(19) United States
(12) Patent Application Publication
(10) Pub. No.: US 2026/0236269 A1
(43) Pub. Date: Aug. 13, 2026

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventor: Yusuke KAMOI, Kanagawa (JP)

(73) Assignee: FUJIFILM Business Innovation Corp., Tokyo (JP)

(21) Appl. No.: 19/298,292

(22) Filed: Aug. 13, 2025

(30) Foreign Application Priority Data
Feb. 7, 2025 (JP) 2025-019264

(51) Int. Cl. G06F 9/445

(52) U.S. Cl. CPC G06F 9/44505

(57) ABSTRACT

An information processing system includes a processor configured to: record setting contents set for each of a plurality of management target apparatuses; reflect setting contents of a setting template in which setting contents are defined for each setting item corresponding to each management target apparatus, in the plurality of management target apparatuses in which a common abnormality has occurred; identify a setting item unrelated to the abnormality from a result of reflecting the setting contents of the setting template corresponding to each management target apparatus; and perform setting such that a setting content of the setting item unrelated to the abnormality, among the setting contents of each of the plurality of management target apparatuses in which the setting contents of the setting template have been reflected, is restored to a state before the setting contents of the setting template are reflected.

### CROSS-REFERENCE TO RELATED APPLICATIONS

This application is based on and claims priority under 35 USC 119 from Japanese Patent Application No. 2025-019264 filed February 7, 2025.

### BACKGROUND

### (i) Technical Field

The present disclosure relates to an information processing system and a non-transitory computer readable medium.

### (ii) Related Art

Japanese Unexamined Patent Application Publication No. 2006-011876 discloses an information processing apparatus capable of identifying, in a short period of time, the cause of a failure that has occurred during print setting and easily investigating a print setting procedure that does not cause a failure.

### SUMMARY

A method for managing settings of a management target apparatus, such as a multifunction peripheral, by using a setting template has been proposed.

With this method, for example, when an abnormality occurs in a management target apparatus due to a user performing setting of a setting content that is different from a setting template, the abnormality can be resolved by reflecting setting contents of the setting template in the management target apparatus.

However, with this method, there is a problem in that setting items unrelated to the abnormality, among setting items that have been changed by the user, are also replaced with the setting contents of the setting template.

Aspects of non-limiting embodiments of the present disclosure relate to an information processing system and a non-transitory computer readable medium that, when setting contents of a setting template have been reflected in a management target apparatus upon occurrence of an abnormality, can restore setting items unrelated to the abnormality to setting contents set by a user.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: record setting contents set for each of a plurality of management target apparatuses; reflect setting contents of a setting template in which setting contents are defined for each setting item corresponding to each management target apparatus, in the plurality of management target apparatuses in which a common abnormality has occurred; identify a setting item unrelated to the abnormality from a result of reflecting the setting contents of the setting template corresponding to each management target apparatus; and perform setting such that a setting content of the setting item unrelated to the abnormality, among the setting contents of each of the plurality of management target apparatuses in which the setting contents of the setting template have been reflected, is restored to a state before the setting contents of the setting template are reflected.

### BRIEF DESCRIPTION OF THE DRAWINGS

Exemplary embodiments of the present disclosure will be described in detail based on the following figures, wherein:

FIG. 1 is a diagram illustrating a system configuration of a setting management system according to a first exemplary embodiment of the present disclosure;

FIG. 2 is a block diagram illustrating a hardware configuration of a management apparatus in the setting management system;

FIG. 3 is a block diagram illustrating a hardware configuration of a management cloud server in the setting management system;

FIG. 4 is a block diagram illustrating a hardware configuration of an image forming apparatus in the setting management system;

FIG. 5 is a diagram for describing a flow of processing performed when an abnormality occurs in the setting management system according to the first exemplary embodiment;

FIG. 6 is a sequence diagram for describing a flow of processing performed when an abnormality occurs in the setting management system according to the first exemplary embodiment;

FIG. 7 is a diagram illustrating a system configuration of a setting management system according to a second exemplary embodiment of the present disclosure;

FIG. 8 is a block diagram illustrating a hardware configuration of a development cloud server in the setting management system;

FIG. 9 is a diagram for describing a flow of processing performed when an abnormality occurs in the setting management system according to the second exemplary embodiment;

FIG. 10 is a sequence diagram for describing a flow of processing performed when an abnormality occurs in the setting management system according to the second exemplary embodiment;

FIG. 11 is a diagram for describing a flow of processing performed when an abnormality occurs in the setting management system according to the second exemplary embodiment; and

FIG. 12 is a sequence diagram for describing a flow of processing performed when an abnormality occurs in the setting management system according to the second exemplary embodiment.

### DETAILED DESCRIPTION

### First Exemplary Embodiment

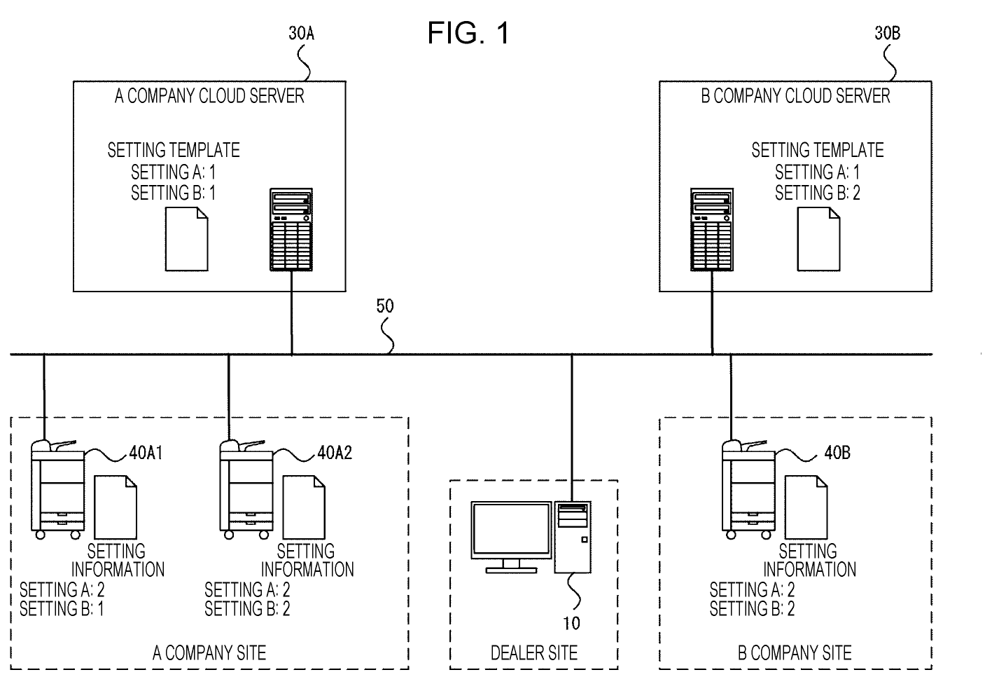

Exemplary embodiments for implementing the technology of the present disclosure will be described in detail below with reference to the accompanying drawings. FIG. 1 is a diagram illustrating a system configuration of a setting management system according to a first exemplary embodiment.

The setting management system according to the present exemplary embodiment is a system that enables a management apparatus 10 installed at a dealer site to collectively manage settings of image forming apparatuses 40A1, 40A2, and 40B installed in respective companies.

As illustrated in FIG. 1, the setting management system according to the present exemplary embodiment includes the management apparatus 10, management cloud servers 30A and 30B, and the image forming apparatuses 40A1, 40A2, and 40B. These apparatuses are connected to Internet 50.

The management apparatus 10 is a terminal that is installed at the dealer site and manages settings of the image forming apparatuses 40A1, 40A2, and 40B installed in the respective companies. The management apparatus 10 is an example of an information processing system according to the technology of the present disclosure.

The management cloud server 30A is a cloud server for managing settings of the image forming apparatuses 40A1 and 40A2 installed at an A company site. The management cloud server 30B is a cloud server for managing settings of the image forming apparatus 40B installed at a B company site.

In the following description, when there is no need to distinguish between the management cloud servers 30A and 30B, each of the management cloud servers 30A and 30B may be simply referred to as a management cloud server 30.

In the present exemplary embodiment, the image forming apparatuses 40A1, 40A2, and 40B are, for example, apparatuses known as multifunction peripherals that have a plurality of functions such as a copying function, a printing function, a faxing function, and a scanning function. The image forming apparatuses 40A1, 40A2, and 40B are each an example of a management target apparatus according to the technology of the present disclosure.

Each of the image forming apparatuses 40A1, 40A2, and 40B is not limited to a multifunction peripheral and may have only a printing function. In the setting management system, the plurality of image forming apparatuses need not be of the same model, and may be of different models.

In the following description, when there is no need to distinguish between the image forming apparatuses 40A1, 40A2, and 40B, each of the image forming apparatuses 40A1, 40A2, and 40B may be simply referred to as an image forming apparatus 40.

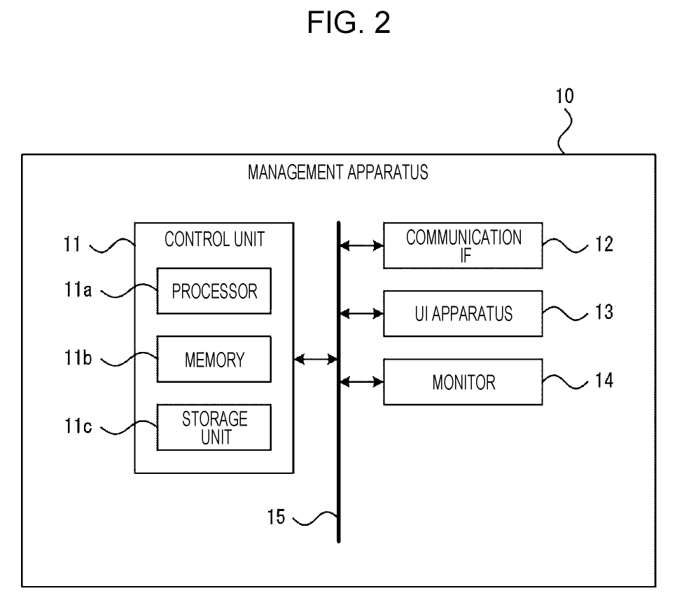

Next, a hardware configuration of the management apparatus 10 according to the present exemplary embodiment will be described. FIG. 2 is a block diagram illustrating a hardware configuration of the management apparatus 10.

As illustrated in FIG. 2, the management apparatus 10 includes a control unit 11, a communication interface (hereinafter, abbreviated as a communication IF) 12, a user interface apparatus (hereinafter, abbreviated as a UI apparatus) 13, and a monitor 14. These components are connected to each other via a control bus 15.

The control unit 11 includes a processor 11a, a memory 11b, and a storage unit 11c. The processor 11a executes predetermined processing based on a program read out from the storage unit 11c and loaded into the memory 11b. The storage unit 11c is configured with, for example, a read-only memory (ROM), a hard disk drive (HDD), or a solid state drive (SSD). Various programs, data, and the like are stored in the storage unit 11c.

While the present exemplary embodiment describes a case where the processor 11a reads out and executes a program stored in the storage unit 11c, the present disclosure is not limited to this case. The program may be provided in a form of being recorded on a computer readable recording medium as described above. Alternatively, the program may be acquired from an external apparatus via a communication line.

The communication IF 12 performs data transmission and reception with an external apparatus or the like. The UI apparatus 13 is an apparatus for a user to input information, such as a mouse and/or a keyboard. The monitor 14 displays various types of information.

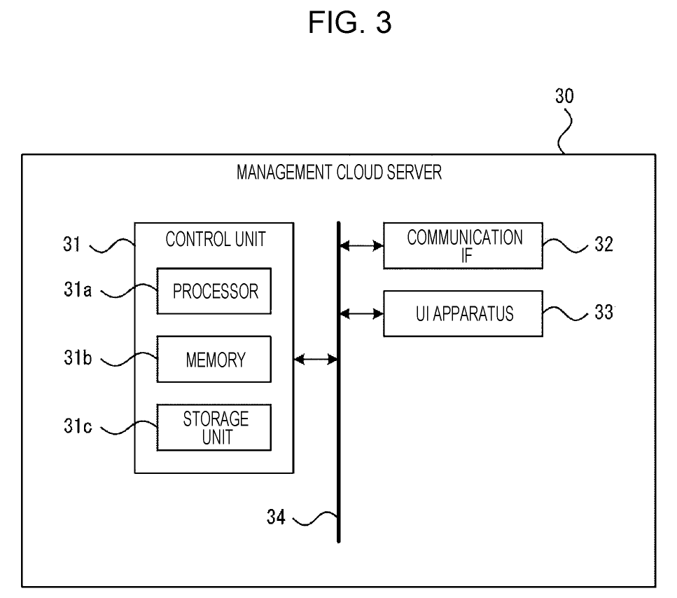

Next, a hardware configuration of the management cloud server 30 according to the present exemplary embodiment will be described. FIG. 3 is a block diagram illustrating a hardware configuration of the management cloud server 30.

As illustrated in FIG. 3, the management cloud server 30 includes a control unit 31, a communication IF 32, and a UI apparatus 33. These components are connected to each other via a control bus 34.

The control unit 31 includes a processor 31a, a memory 31b, and a storage unit 31c. The processor 31a executes predetermined processing based on a program read out from the storage unit 31c and loaded into the memory 31b. The storage unit 31c is configured with, for example, a ROM, an HDD, or an SSD. The storage unit 31c stores various programs, data, and the like.

While the present exemplary embodiment describes a case where the processor 31a reads out and executes a program stored in the storage unit 31c, the present disclosure is not limited to this case. The program may be provided in a form of being recorded on a computer readable recording medium as described above. Alternatively, the program may be acquired from an external apparatus via a communication line.

The communication IF 32 performs data transmission and reception with an external apparatus or the like. The UI apparatus 33 is an apparatus for a user to input information, such as a mouse and/or a keyboard.

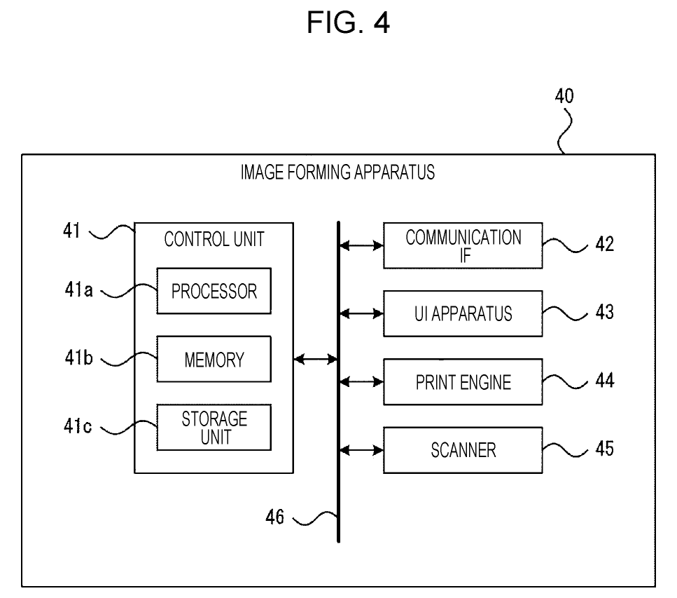

Next, a hardware configuration of the image forming apparatus 40 according to the present exemplary embodiment will be described. FIG. 4 is a block diagram illustrating a hardware configuration of the image forming apparatus 40.

As illustrated in FIG. 4, the image forming apparatus 40 includes a control unit 41, a communication IF 42, a UI apparatus 43, a print engine 44, and a scanner 45. These components are connected to each other via a control bus 46.

The control unit 41 includes a processor 41a, a memory 41b, and a storage unit 41c. The processor 41a executes predetermined processing based on a program read out from the storage unit 41c and loaded into the memory 41b. The storage unit 41c is configured with, for example, a ROM, an HDD, or an SSD. The storage unit 41c stores various programs, data, and the like.

While the present exemplary embodiment describes a case where the processor 41a reads out and executes a program stored in the storage unit 41c, the present disclosure is not limited to this case. The program may be provided in a form of being recorded on a computer readable recording medium as described above. Alternatively, the program may be acquired from an external apparatus via a communication line.

The communication IF 42 performs data transmission and reception with an external apparatus or the like. The UI apparatus 43 is an apparatus for a user to receive or input information, such as a touch panel and/or a button. The print engine 44 prints an image on a recording medium such as a printing sheet through processes such as charging, exposure, development, transfer, and fixing. The scanner 45 reads a document loaded in the image forming apparatus 40 as image data.

In the setting management system according to the present exemplary embodiment, as illustrated in FIG. 1, the management cloud servers 30A and 30B are installed for respective companies. The management cloud servers 30A and 30B each manage a setting template for the corresponding company. In the setting template, setting contents are defined for respective setting items of the image forming apparatus 40. The setting contents of the setting template are set so as not to interfere with the operation of the image forming apparatus 40.

Normally, the image forming apparatuses 40 of the respective companies operate with any setting contents. When an abnormality occurs in the image forming apparatus 40, for each company, the management cloud servers 30A and 30B are connected to the image forming apparatuses 40 managed by respective servers, and the setting contents of the image forming apparatuses 40 of the respective companies can be collectively changed to the setting contents of the setting templates of the respective companies.

With this configuration, even when an abnormality occurs in the image forming apparatus 40, the image forming apparatus 40 may be restored to an operable state.

However, with this method, there is a problem in that a setting item unrelated to the abnormality, among setting items that have been changed by the user, is also replaced with the setting contents of the setting template.

To solve such a problem, the control unit 11 of the management apparatus 10 according to the present exemplary embodiment records setting contents set for each of the plurality of image forming apparatuses 40, reflects setting contents of a setting template corresponding to each image forming apparatus 40, in the plurality of image forming apparatuses 40 in which a common abnormality has occurred, identifies a setting item unrelated to the abnormality from a result of reflecting the setting contents of the setting template corresponding to each image forming apparatus 40, and performs setting such that a setting content of the setting item unrelated to the abnormality, among the setting contents of each of the plurality of image forming apparatuses 40 in which the setting contents of the setting template have been reflected, is restored to a state before the setting contents of the setting template are reflected.

The setting contents set for each of the plurality of image forming apparatuses 40 may be recorded by the management apparatus 10. The setting contents set for each of the plurality of image forming apparatuses 40 may be recorded by the management cloud server 30 in accordance with an instruction from the control unit 11 of the management apparatus 10.

Additionally, the control unit 11 may identify the setting item unrelated to the abnormality when the abnormality has not recurred for a set period after the setting contents of the setting template corresponding to each image forming apparatus 40 are reflected, and perform the setting such that the setting content of the setting item unrelated to the abnormality, among the setting contents of each of the plurality of image forming apparatuses 40 in which the setting contents of the setting template have been reflected, is restored to the state before the setting contents of the setting template are reflected.

In the present exemplary embodiment, the processing of reflecting the setting contents of the setting template corresponding to each image forming apparatus 40 is performed via the management cloud server 30 of each company. However, the processing of reflecting the setting contents of the setting template corresponding to each image forming apparatus 40 may be performed directly by the management apparatus 10.

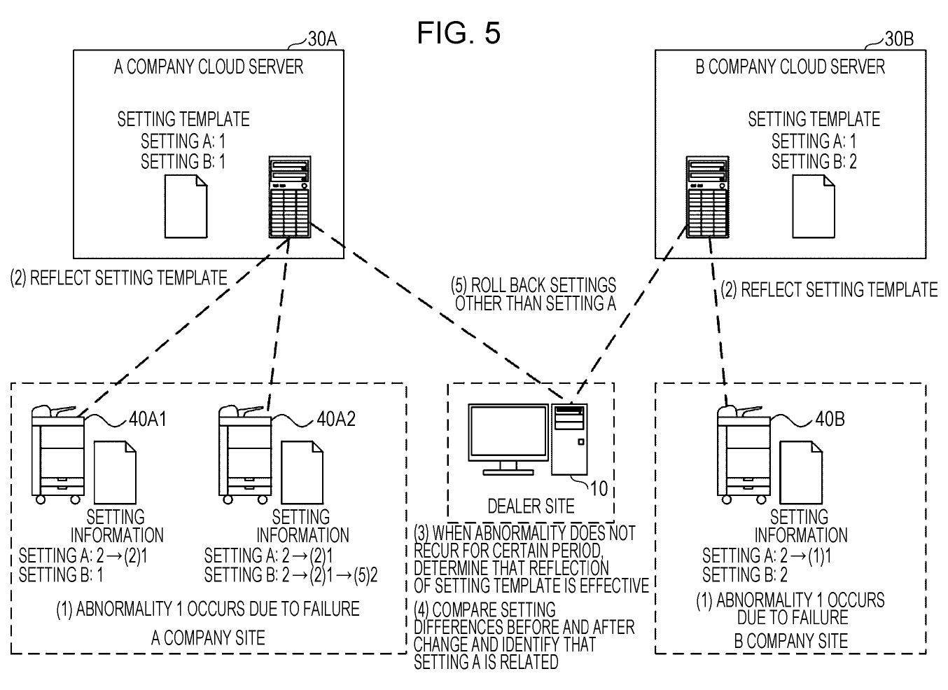

Processing performed in the setting management system according to the present exemplary embodiment will be described in detail below with reference to FIG. 5. In the following description, for ease of understanding, each apparatus will be described as a subject of processing, but in reality, the control unit of each apparatus performs the processing.

As illustrated in FIG. 5, in step 1, a common abnormality 1 occurs due to a failure in the image forming apparatuses 40 installed in the respective companies.

Next, in step 2, the management apparatus 10 instructs the management cloud servers 30 of the respective companies to reflect setting contents of a setting template in the image forming apparatuses 40 of the respective companies.

Next, in step 3, when the abnormality 1 does not recur for a certain period in the image forming apparatus 40 of each company, the management apparatus 10 determines that the reflection of the setting template is effective.

Next, in step 4, the management apparatus 10 compares setting differences before and after the change and identifies that a setting A is related.

Here, a method for extracting a setting item related to an abnormality and a setting item unrelated to an abnormality will be described in detail.

Before the setting contents of the setting template are reflected in the image forming apparatuses 40 of the respective companies, the setting A of the image forming apparatuses 40 of the respective companies is all "2". With regard to a setting B of the image forming apparatuses 40 of the respective companies, "1" and "2" coexist.

As a result of the setting contents of the setting template being reflected in the image forming apparatuses 40 of the respective companies after the detection of the abnormality 1, the setting A of the image forming apparatuses 40 of the respective companies is all "1". With regard to the setting B of the image forming apparatuses 40 of the respective companies, "1" and "2" coexist.

In such a situation, when the abnormality 1 does not recur for a certain period, it can be identified that the setting A is related to the abnormality 1 and that setting the setting A to "2" is the cause of the abnormality 1. In addition, it can be identified that the setting B is unrelated to the abnormality 1.

For this reason, in step 5, the management apparatus 10 instructs the management cloud servers 30 of the respective companies to restore the settings of the image forming apparatuses 40 of the respective companies other than the setting A to the state before the setting contents of the setting template are reflected. Restoring the settings of the image forming apparatus 40 to the state before the setting contents of the setting template are reflected hereinafter is referred to as rollback.

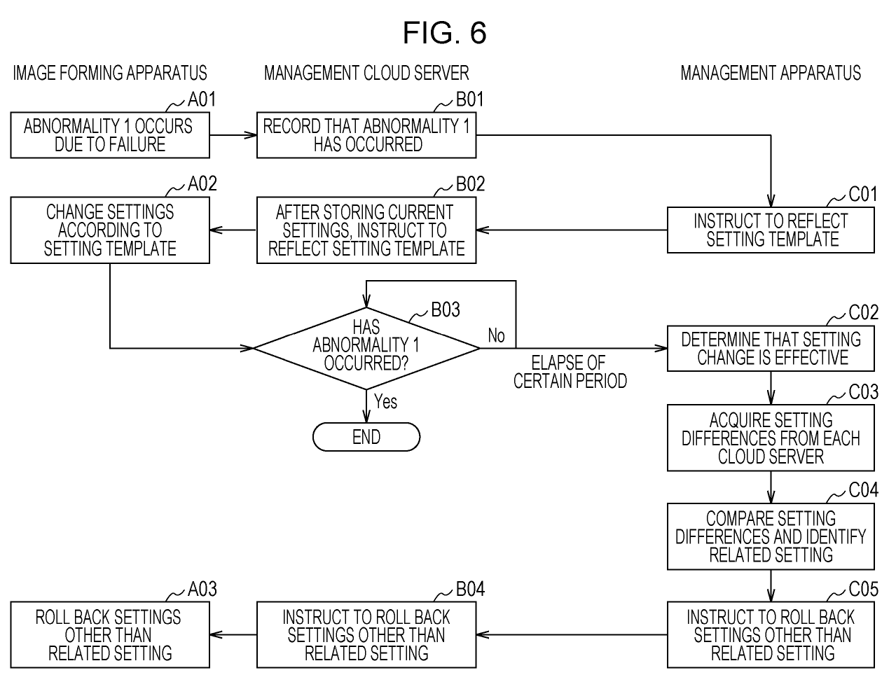

Next, with reference to a sequence diagram of FIG. 6, a description will be given regarding a flow of processing performed when an abnormality occurs in the setting management system according to the present exemplary embodiment.

When the abnormality 1 occurs due to a failure in step A01, the image forming apparatus 40 installed in each company notifies the management cloud server 30 of the company of the occurrence of the abnormality 1.

In step B01, the management cloud server 30 of the company records that the abnormality 1 has occurred, and notifies the management apparatus 10 of the occurrence of the abnormality 1.

When the abnormality 1 has occurred commonly in the image forming apparatuses 40 installed in the respective companies, in step C01, the management apparatus 10 instructs the management cloud servers 30 of the respective companies to reflect setting contents of a setting template in the image forming apparatuses 40 of the respective companies.

In step B02, the management cloud servers 30 of the respective companies store the setting contents of the image forming apparatuses 40 installed in the respective companies, and then instruct the image forming apparatuses 40 installed in the respective companies to reflect the setting contents of the setting template.

In step A02, the image forming apparatuses 40 installed in the respective companies change the setting contents according to the setting template.

In step B03, the management cloud servers 30 of the respective companies determine whether the abnormality 1 has occurred in the image forming apparatuses 40 of the respective companies after the setting change, and end the processing when the abnormality 1 has occurred. When the abnormality 1 has not recurred for a certain period, the management cloud servers 30 of the respective companies notify the management apparatus 10 that the abnormality 1 has not occurred after the setting change.

When the management apparatus 10 receives the notification indicating that the abnormality 1 has not occurred after the setting change, in step C02, the management apparatus 10 determines that the setting change is effective, and in step C03, acquires setting differences from the management cloud servers 30 of the respective companies.

Next, in step C04, the management apparatus 10 compares the setting differences and identifies a setting related to the abnormality 1.

Next, in step C05, the management apparatus 10 instructs the management cloud servers 30 of the respective companies to roll back settings other than the setting related to the abnormality 1 in the image forming apparatuses 40 of the respective companies.

In step B04, the management cloud servers 30 of the respective companies instruct the image forming apparatuses 40 installed in the respective companies to roll back the settings other than the setting related to the abnormality 1.

In step A03, the image forming apparatuses 40 installed in the respective companies roll back the settings other than the setting related to the abnormality 1 in accordance with the rollback instruction.

### Second Exemplary Embodiment

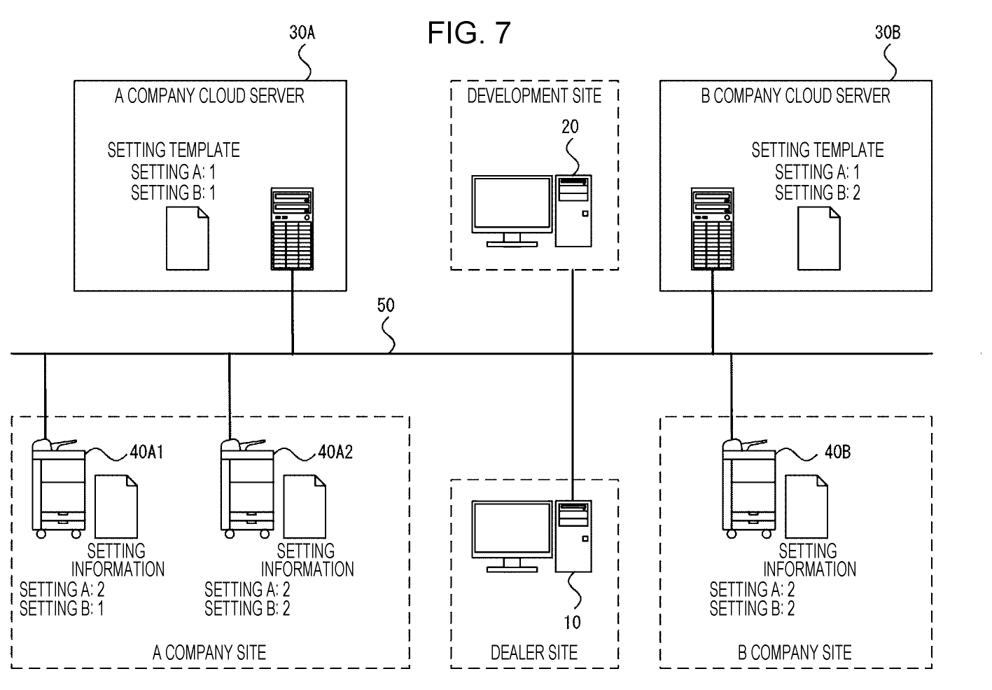

Next, a setting management system according to a second exemplary embodiment will be described. FIG. 7 is a diagram illustrating a system configuration of the setting management system according to the second exemplary embodiment.

As illustrated in FIG. 7, the setting management system according to the present exemplary embodiment includes the management apparatus 10, a development cloud server 20, the management cloud servers 30A and 30B, and the image forming apparatuses 40A1, 40A2, and 40B. These apparatuses are connected to the Internet 50.

The setting management system according to the present exemplary embodiment is different from the setting management system according to the first exemplary embodiment in that the development cloud server 20 is added, and the processing performed by the management apparatus 10 is distributed to and performed by the management apparatus 10 and the development cloud server 20.

The components other than the development cloud server 20 are the same as those of the setting management system according to the first exemplary embodiment, and a detailed description thereof will be omitted.

The development cloud server 20 is installed at a development site different from the dealer site.

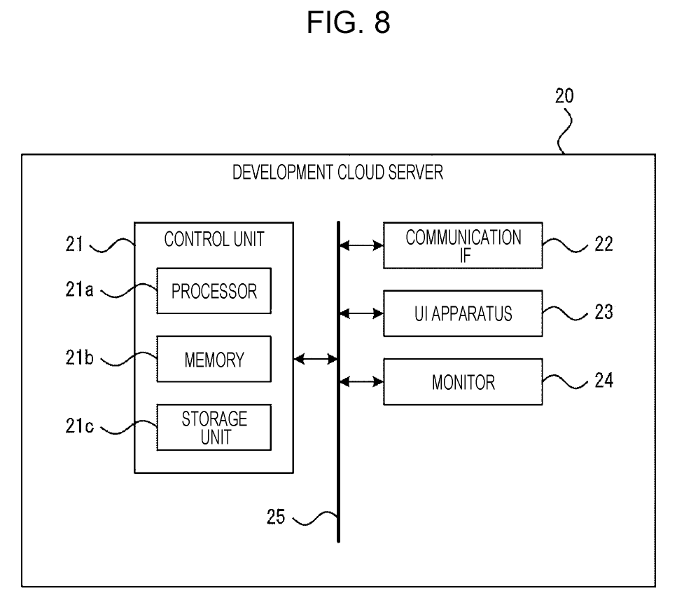

Next, a hardware configuration of the development cloud server 20 according to the present exemplary embodiment will be described. FIG. 8 is a block diagram illustrating a hardware configuration of the development cloud server 20.

As illustrated in FIG. 8, the development cloud server 20 includes a control unit 21, a communication IF 22, a UI apparatus 23, and a monitor 24. These components are connected to each other via a control bus 25. The control unit 21 includes a processor 21a, a memory 21b, and a storage unit 21c. These components are the same as those of the management apparatus 10, and a detailed description thereof will be omitted.

In the present exemplary embodiment, the control unit 11 of the management apparatus 10 records setting contents set for each of the plurality of image forming apparatuses 40, and reflects setting contents of a setting template corresponding to each image forming apparatus 40 in the plurality of image forming apparatuses 40 in which a common abnormality has occurred.

The control unit 21 of the development cloud server 20 identifies a setting item unrelated to the abnormality from a result of reflecting the setting contents of the setting template corresponding to each image forming apparatus 40.

Then, the control unit 11 of the management apparatus 10 performs setting such that a setting content of the setting item unrelated to the abnormality, among the setting contents of each of the plurality of image forming apparatuses 40 to which the setting contents of the setting template have been reflected, is restored to a state before the setting contents of the setting template are reflected.

The processor 11a of the control unit 11 of the management apparatus 10 is an example of a first processor according to the technology of the present disclosure. The processor 21a of the control unit 21 of the development cloud server 20 is an example of a second processor according to the technology of the present disclosure.

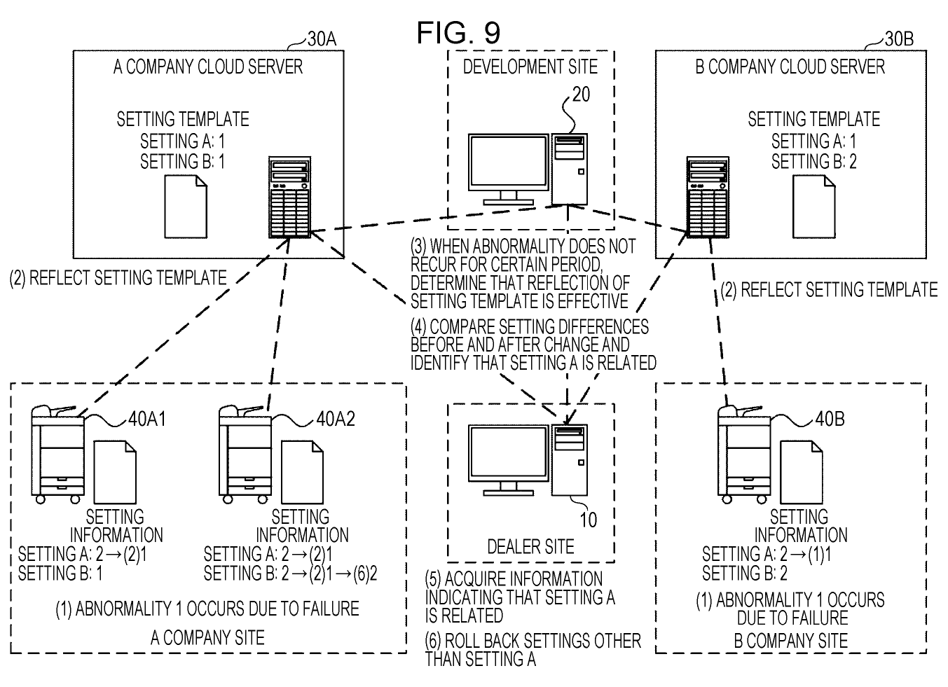

Processing performed in the setting management system according to the present exemplary embodiment will be described in detail below with reference to FIG. 9. In the following description, for ease of understanding, each apparatus will be described as a subject of processing, but in reality, the control unit of each apparatus performs the processing.

As illustrated in FIG. 9, in step 1, a common abnormality 1 occurs due to a failure in the image forming apparatuses 40 installed in the respective companies.

Next, in step 2, the management apparatus 10 instructs the management cloud servers 30 of the respective companies to reflect setting contents of a setting template in the image forming apparatuses 40 of the respective companies.

Next, in step 3, when the abnormality 1 does not recur for a certain period in the image forming apparatuses 40 of the respective companies, the development cloud server 20 determines that the reflection of the setting template is effective.

Next, in step 4, the development cloud server 20 compares setting differences before and after the change and identifies that a setting A is related. The development cloud server 20 notifies the management apparatus 10 of the identified result.

When the management apparatus 10 acquires information indicating that the setting A is related to the abnormality 1 from the development cloud server 20 in step 5, in step 6, the management apparatus 10 instructs the management cloud servers 30 of the respective companies to roll back settings other than the setting A for the image forming apparatuses 40 of the respective companies.

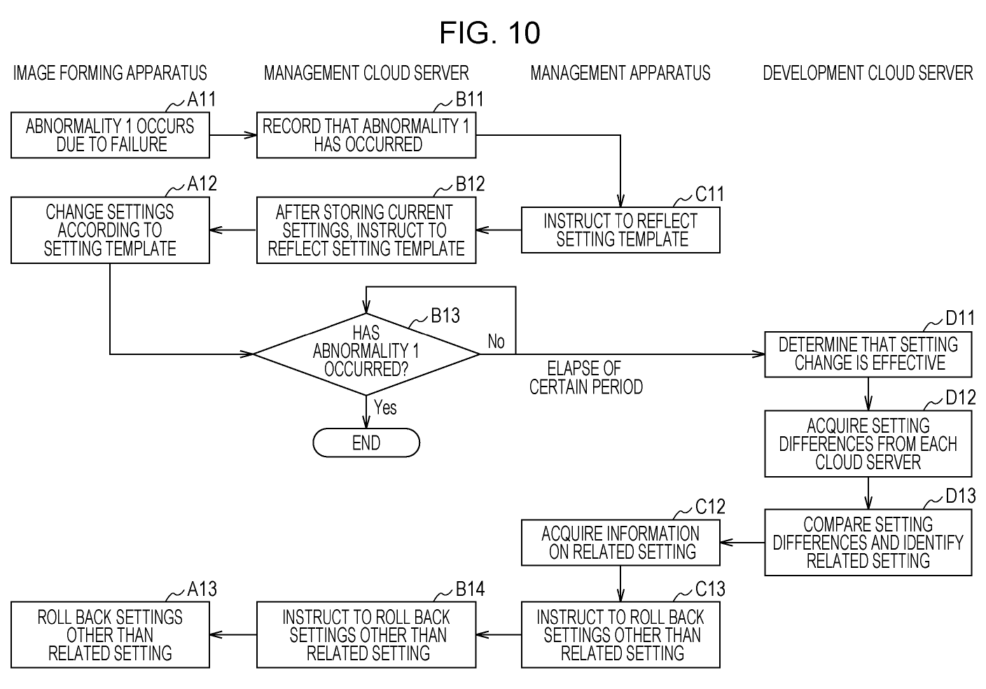

Next, with reference to a sequence diagram of FIG. 10, a description will be given regarding a flow of processing performed when an abnormality occurs in the setting management system according to the present exemplary embodiment.

When the abnormality 1 occurs due to a failure in step A11, the image forming apparatus 40 installed in each company notifies the management cloud server 30 of the company of the occurrence of the abnormality 1.

In step B11, the management cloud server 30 of each company records that the abnormality 1 has occurred, and notifies the management apparatus 10 of the occurrence of the abnormality 1.

When the abnormality 1 has occurred commonly in the image forming apparatuses 40 installed in the respective companies, in step C11, the management apparatus 10 instructs the management cloud servers 30 of the respective companies to reflect setting contents of a setting template in the image forming apparatuses 40 of the respective companies.

In step B12, the management cloud servers 30 of the respective companies store the setting contents of the image forming apparatuses 40 installed in the respective companies, and then instruct the image forming apparatuses 40 installed in the respective companies to reflect the setting contents of the setting template.

In step A12, the image forming apparatuses 40 installed in the respective companies change the setting contents according to the setting template.

In step B13, the management cloud servers 30 of the respective companies determine whether the abnormality 1 has occurred in the image forming apparatuses 40 of the respective companies after the setting change, and end the processing when the abnormality 1 has occurred. When the abnormality 1 has not recurred for a certain period, the management cloud servers 30 of the respective companies notify the development cloud server 20 that the abnormality 1 has not occurred after the setting change.

When the development cloud server 20 receives the notification indicating that the abnormality 1 has not occurred after the setting change, in step D11, the development cloud server 20 determines that the setting change is effective, and in step D12, acquires setting differences from the management cloud servers 30 of the respective companies.

Next, in step D13, the development cloud server 20 compares the setting differences, identifies a setting related to the abnormality 1, and notifies the management apparatus 10 of the result.

When the management apparatus 10 acquires the information on the setting related to the abnormality 1 in step C12, in step C13, the management apparatus 10 instructs the management cloud servers 30 of the respective companies to roll back settings other than the setting related to the abnormality 1 in the image forming apparatuses 40 of the respective companies.

In step B14, the management cloud servers 30 of the respective companies instruct the image forming apparatuses 40 installed in the respective companies to roll back settings other than the setting related to the abnormality 1.

In step A13, the image forming apparatuses 40 installed in the respective companies roll back settings other than the setting related to the abnormality 1 in accordance with the rollback instruction.

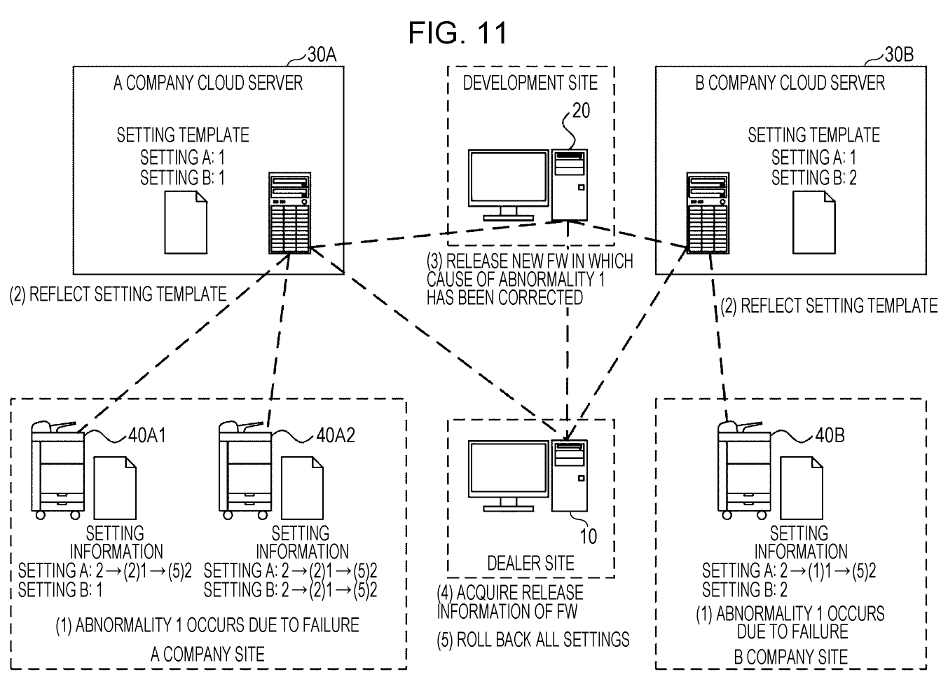

Next, with reference to FIG. 11, a detailed description will be given regarding processing performed when new firmware for coping with an abnormality in the image forming apparatus 40 is released in the setting management system according to the present exemplary embodiment. The firmware for the image forming apparatus 40 is an example of control software for a management target apparatus according to the technology of the present disclosure. In the following description, for ease of understanding, each apparatus will be described as a subject of processing, but in reality, the control unit of each apparatus performs the processing.

As illustrated in FIG. 11, in step 1, a common abnormality 1 occurs due to a failure in the image forming apparatuses 40 installed in the respective companies.

Next, in step 2, the management apparatus 10 instructs the management cloud servers 30 of the respective companies to reflect setting contents of a setting template in the image forming apparatuses 40 of the respective companies.

Next, in step 3, the development cloud server 20 releases new firmware obtained by correcting the cause of the abnormality 1, and notifies the management apparatus 10 that the new firmware has been released.

When the management apparatus 10 acquires the release information of the new firmware in step 4, in step 5, the management apparatus 10 instructs the management cloud servers 30 of the respective companies to roll back all settings of the image forming apparatuses 40 of the respective companies.

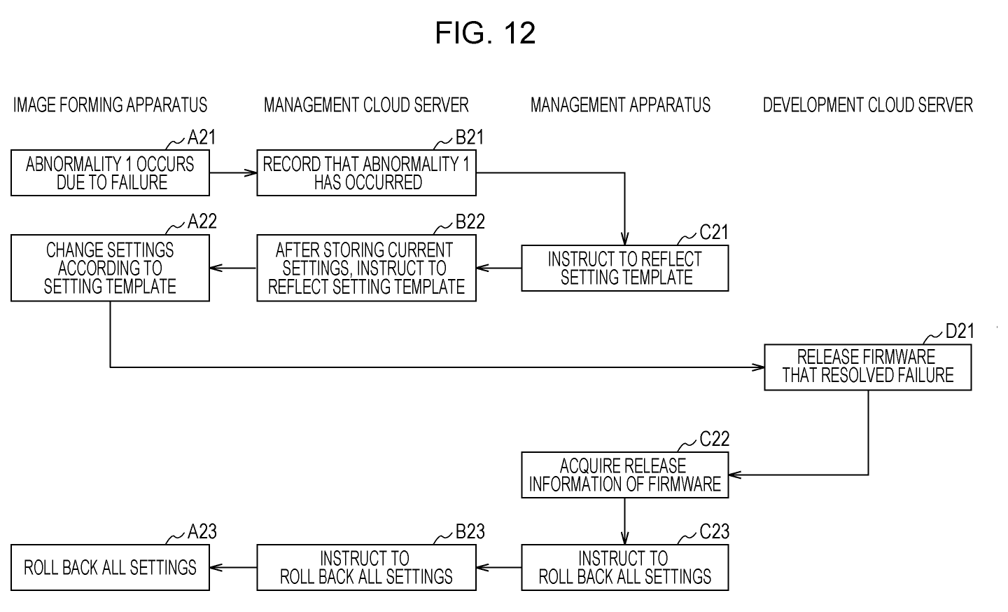

Next, with reference to a sequence diagram illustrated in FIG. 12, a description will be given regarding a flow of processing performed when new firmware is released in the setting management system according to the present exemplary embodiment.

When an abnormality 1 occurs due to a failure in step A21, the image forming apparatus 40 installed in each company notifies the management cloud server 30 of the company of the occurrence of the abnormality 1.

In step B21, the management cloud server 30 of each company records that the abnormality 1 has occurred, and notifies the management apparatus 10 of the occurrence of the abnormality 1.

When the abnormality 1 has occurred commonly in the image forming apparatuses 40 installed in the respective companies, in step C21, the management apparatus 10 instructs the management cloud servers 30 of the respective companies to reflect setting contents of a setting template in the image forming apparatuses 40 of the respective companies.

In step B22, the management cloud servers 30 of the respective companies store the setting contents of the image forming apparatuses 40 installed in the respective companies, and then instruct the image forming apparatuses 40 installed in the respective companies to reflect the setting contents of the setting template.

In step A22, the image forming apparatuses 40 installed in the respective companies change the setting contents according to the setting template.

In step D21, the development cloud server 20 releases new firmware in which the cause of the abnormality 1 has been corrected, and notifies the management apparatus 10 that the new firmware has been released.

When the management apparatus 10 acquires the release information of the new firmware in step C22, the management apparatus 10 instructs the management cloud servers 30 of the respective companies to roll back all settings of the image forming apparatuses 40 of the respective companies in step C23.

In step B23, the management cloud servers 30 of the respective companies instruct the image forming apparatuses 40 installed in the respective companies to roll back all settings.

In step A23, the image forming apparatuses 40 installed in the respective companies roll back all settings in accordance with the rollback instruction.

### Modification

While the setting management system according to the exemplary embodiments of the present disclosure has been described above, the technology of the present disclosure is not limited to the above-described exemplary embodiments and may be modified as appropriate.

For example, when the development cloud server 20 is provided separately from the management apparatus 10, the management apparatus 10 and the development cloud server 20 may be installed at the same site, not limited to being installed at different sites.

In the embodiments above, the term "processor" refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

The operations of the processor according to the above-described exemplary embodiment may be performed by not only a single processor but also a plurality of processors that are physically distant from each other and operate in cooperation with each other. The order of operations of the processor is not limited to one described in the embodiments above, and may be changed.

In the technology of the present disclosure, a system includes both a system configured by a plurality of apparatuses and a system configured by a single apparatus.

The technology of the present disclosure may also be applied to a program and a program product.

### Appendix

(((1)))

An information processing system comprising: a processor configured to: record setting contents set for each of a plurality of management target apparatuses; reflect setting contents of a setting template in which setting contents are defined for each setting item corresponding to each management target apparatus, in the plurality of management target apparatuses in which a common abnormality has occurred; identify a setting item unrelated to the abnormality from a result of reflecting the setting contents of the setting template corresponding to each management target apparatus; and perform setting such that a setting content of the setting item unrelated to the abnormality, among the setting contents of each of the plurality of management target apparatuses in which the setting contents of the setting template have been reflected, is restored to a state before the setting contents of the setting template are reflected.

(((2)))

The information processing system according to (((1))), wherein the processor is configured to: identify the setting item unrelated to the abnormality when the abnormality has not recurred for a set period after the setting contents of the setting template corresponding to each management target apparatus are reflected; and perform the setting such that the setting content of the setting item unrelated to the abnormality, among the setting contents of each of the plurality of management target apparatuses in which the setting contents of the setting template have been reflected, is restored to the state before the setting contents of the setting template are reflected.

(((3)))

The information processing system according to (((1))) or (((2))), wherein the processor is configured to perform the setting such that all the setting contents of each of the plurality of management target apparatuses in which the setting contents of the setting template have been reflected are restored to the state before the setting contents of the setting template are reflected, when control software for the management target apparatus that prevents the abnormality from occurring is installed in the management target apparatus after the setting contents of the setting template corresponding to each management target apparatus are reflected.

(((4)))

The information processing system according to any one of (((1))) to (((3))), wherein the management target apparatuses are connected to different servers for respective organizations that use the management target apparatuses, and the processor is configured to perform the setting of the management target apparatuses via the servers for the respective organizations.

(((5)))

The information processing system according to (((4))), wherein the processor is configured to, for each organization, cause the management target apparatus connected to the server to reflect the setting contents of the setting template stored in the server.

(((6)))

The information processing system according to any one of (((1))) to (((5))), wherein the processor includes a first processor and a second processor, the first processor is configured to reflect the setting contents of the setting template in which setting contents are defined for each setting item corresponding to each management target apparatus, in the plurality of management target apparatuses in which the common abnormality has occurred, the second processor is configured to identify the setting item unrelated to the abnormality from the result of reflecting the setting contents of the setting template corresponding to each management target apparatus, and the first processor is configured to perform the setting such that the setting content of the setting item unrelated to the abnormality identified by the second processor, among the setting contents of each of the plurality of management target apparatuses in which the setting contents of the setting template have been reflected, is restored to the state before the setting contents of the setting template are reflected.

(((7)))

The information processing system according to (((6))), wherein the first processor and the second processor are installed at different locations.

(((8)))

A program causing a computer to execute a process comprising: recording setting contents set for each of a plurality of management target apparatuses; reflecting setting contents of a setting template in which setting contents are defined for each setting item corresponding to each management target apparatus, in the plurality of management target apparatuses in which a common abnormality has occurred; identifying a setting item unrelated to the abnormality from a result of reflecting the setting contents of the setting template corresponding to each management target apparatus; and performing setting such that a setting content of the setting item unrelated to the abnormality, among the setting contents of each of the plurality of management target apparatuses in which the setting contents of the setting template have been reflected, is restored to a state before the setting contents of the setting template are reflected.

What is claimed is:

1. An information processing system comprising:
a processor configured to:
record setting contents set for each of a plurality of management target apparatuses;
reflect setting contents of a setting template in which setting contents are defined for each setting item corresponding to each management target apparatus, in the plurality of management target apparatuses in which a common abnormality has occurred;
identify a setting item unrelated to the abnormality from a result of reflecting the setting contents of the setting template corresponding to each management target apparatus; and
perform setting such that a setting content of the setting item unrelated to the abnormality, among the setting contents of each of the plurality of management target apparatuses in which the setting contents of the setting template have been reflected, is restored to a state before the setting contents of the setting template are reflected.

2. The information processing system according to claim 1, wherein
the processor is configured to:
identify the setting item unrelated to the abnormality when the abnormality has not recurred for a set period after the setting contents of the setting template corresponding to each management target apparatus are reflected; and
perform the setting such that the setting content of the setting item unrelated to the abnormality, among the setting contents of each of the plurality of management target apparatuses in which the setting contents of the setting template have been reflected, is restored to the state before the setting contents of the setting template are reflected.

3. The information processing system according to claim 1, wherein
the processor is configured to
perform the setting such that all the setting contents of each of the plurality of management target apparatuses in which the setting contents of the setting template have been reflected are restored to the state before the setting contents of the setting template are reflected, when control software for the management target apparatus that prevents the abnormality from occurring is installed in the management target apparatus after the setting contents of the setting template corresponding to each management target apparatus are reflected.

4. The information processing system according to claim 1, wherein
the management target apparatuses are connected to different servers for respective organizations that use the management target apparatuses, and
the processor is configured to perform the setting of the management target apparatuses via the servers for the respective organizations.

5. The information processing system according to claim 4, wherein
the processor is configured to, for each organization, cause the management target apparatus connected to the server to reflect the setting contents of the setting template stored in the server.

6. The information processing system according to claim 1, wherein
the processor includes a first processor and a second processor,
the first processor is configured to reflect the setting contents of the setting template in which setting contents are defined for each setting item corresponding to each management target apparatus, in the plurality of management target apparatuses in which the common abnormality has occurred,
the second processor is configured to identify the setting item unrelated to the abnormality from the result of reflecting the setting contents of the setting template corresponding to each management target apparatus, and
the first processor is configured to perform the setting such that the setting content of the setting item unrelated to the abnormality identified by the second processor, among the setting contents of each of the plurality of management target apparatuses in which the setting contents of the setting template have been reflected, is restored to the state before the setting contents of the setting template are reflected.

7. The information processing system according to claim 6, wherein
the first processor and the second processor are installed at different locations.

8. A non-transitory computer readable medium storing a program causing a computer to execute a process comprising:
recording setting contents set for each of a plurality of management target apparatuses;
reflecting setting contents of a setting template in which setting contents are defined for each setting item corresponding to each management target apparatus, in the plurality of management target apparatuses in which a common abnormality has occurred;
identifying a setting item unrelated to the abnormality from a result of reflecting the setting contents of the setting template corresponding to each management target apparatus; and
performing setting such that a setting content of the setting item unrelated to the abnormality, among the setting contents of each of the plurality of management target apparatuses in which the setting contents of the setting template have been reflected, is restored to a state before the setting contents of the setting template are reflected.
